(19) United States
(12) Patent Application Publication
(10) Pub. No.: US 2009/0223152 A1
(43) Pub. Date: Sep. 10, 2009

(54) Wire Tray Stock

(75) Inventor: Martin Lee Witherbee, Godfrey, IL (US)

Correspondence Address: SENNIGER POWERS LLP, 100 NORTH BROADWAY, 17TH FLOOR, ST LOUIS, MO, 63102, US

(73) Assignee: COOPER TECHNOLOGIES COMPANY, Houston, TX (US)

(21) Appl. No.: 12/044,467

(22) Filed: Mar. 7, 2008

(51) Int. Cl. E04B 5/48; A47F 5/01; B23P 11/00

(52) U.S. Cl. 52/220.1; 211/126.9; 29/428

(57) ABSTRACT

A wire tray stock includes a first and second wire tray modules extending along a length of the wire tray stock and being integrally connected to one another. A cross-cut zone extends transverse to the wire tray stock between the modules. The cross-cut zone has a width defined by the distance between adjacent end cross wires of the first and second tray modules. The width is less than first distance intervals between intermediate cross wires of the first and second wire tray modules so that the first and second wire tray modules are individually discernible from each other and can be detached from the wire tray stock by cutting through one or more selected cross-cut zones.

### FIELD OF THE INVENTION

The present invention generally relates to wire tray stock comprising a plurality of wire tray modules.

### BACKGROUND

In raised floor systems, floor panels are supported by a series of pedestals or columns secured to a subfloor. The floor panels are usually square, and the supporting pedestals are typically arranged in a grid formation (e.g., a 2′×2′ formation) so as to define a series of generally cuboidal spaces between adjacent pedestals. Cable routed through the under-floor space is supported in trays (e.g., basket cable trays) that run between the pedestals supporting the floor.

Typically, the trays are wire trays comprising a plurality of longitudinal wires and a plurality of cross wires extending generally transverse to the longitudinal wires. The cross wires are spaced at uniform intervals along the entire length of the tray. The trays can be selectively cut at the jobsite to form shorter tray segments, depending on the desired layout of the trays underneath the floor. A shorter tray segment is cut from a wire tray at the job site by measuring the desired length of the tray segment and transversely cutting the longitudinal wires between the uniformly spaced cross wires.

### SUMMARY

In one aspect, wire tray stock generally comprises adjacent first and second wire tray modules extending along a length of the wire tray stock. The modules are integrally connected to one another and have generally uniform lengths. A cross-cut zone extends transverse to the wire tray stock between the first and second tray modules. Each of the first and second modules comprises opposite end cross wires extending generally transverse to the length of the wire tray stock and defining opposite longitudinal ends of the wire tray module. A plurality of intermediate cross wires are disposed between the end cross wires and extend generally transverse to the length of the wire tray stock. Adjacent cross wires of the plurality of intermediate cross wires are spaced apart by first distance intervals along the length of the wire tray stock. The cross-cut zone has a width defined by the distance between adjacent end cross wires of the first and second tray modules. The width is less than the first distance intervals between the intermediate cross wires of the wire tray modules. The first and second wire tray modules are detachable from each other by cutting through the cross-cut zone.

In another aspect, a method of making wire tray stock comprising a plurality of integral wire tray modules integrally connected to one another and having generally uniform lengths generally comprises providing a plurality of generally parallel, spaced apart longitudinal wires arranged to extend along a length of the wire tray stock. A plurality of first cross wires are secured to the longitudinal wires so that the first cross wires are generally transverse to the longitudinal wires and are spaced from one another a first distance along the length of the wire tray stock. At least one pair of adjacent second cross wires are secured to said longitudinal wires so that the second cross wires of said pair are generally transverse to the longitudinal wires and spaced from one another a second distance along the length of the wire tray stock that is less than the first distance between adjacent first cross wires. The adjacent second cross wires define a cross-cut zone between adjacent wire tray modules.

In yet another aspect, a method of selling wire tray stock generally comprises offering for sale the wire tray stock comprising a plurality of wire tray modules integrally connected and spaced apart along a length of the wire tray stock. The wire tray modules are visually discernible from each other along the length of the wire tray stock so that the modules can be identified and selectively cut from the wire tray stock in the field.

In another aspect, wire tray stock generally comprises a plurality of wire tray modules extending along a length of the wire tray stock. The modules are integrally connected to one another and have generally uniform lengths. A plurality of cross-cut zones extend transverse to the wire tray stock between the modules. Each wire tray module of said plurality of modules comprises opposite end cross wires extending generally transverse to the length of the wire tray stock and defining opposite longitudinal ends of said wire tray module. A plurality of intermediate cross wires are disposed between the end cross wires and extend generally transverse to the length of the wire tray stock. Adjacent cross wires of the plurality of intermediate cross wires are spaced apart by first distance intervals along the length of the wire tray stock. Each cross-cut zone of the plurality of cross-cut zones has a width defined by the distance between adjacent end cross wires of respective adjacent tray modules. The combined widths of the cross-cut zones are less than about 20% of the length of the wire tray stock.

### BRIEF DESCRIPTION OF THE DRAWINGS

FIG. 1 is a perspective of one embodiment of wire tray stock including a plurality of tray modules;

FIG. 2 a top plan view of the wire tray stock of FIG. 1;

FIG. 3A is an enlarged, partial top plan view of FIG. 2;

FIG. 3B is an enlarged, partial top plan view of FIG. 3A;

FIG. 4 is an enlarged, partial top plan view of FIG. 3A illustrating cuts made through a cross-cut zone of the stock to separate adjacent tray modules;

FIG. 5 is an enlarged perspective of one of the tray modules cut from the wire tray stock;

FIG. 6 is a perspective of an underfloor cable management system including wire tray modules individually mounted to tray stands;

FIG. 7 is similar to FIG. 6 except that the tray stock is mounted on the tray stands as a unit; and

FIG. 8A is similar to FIG. 2 except that scrap regions of the wire tray stock are shaded for illustrative purposes; and

FIG. 8B is a top plan view of a conventional wire tray unit with scrap regions of the unit shaded for illustrative purposes.

Corresponding reference characters indicate corresponding parts throughout the drawings.

### DETAILED DESCRIPTION OF THE DRAWINGS

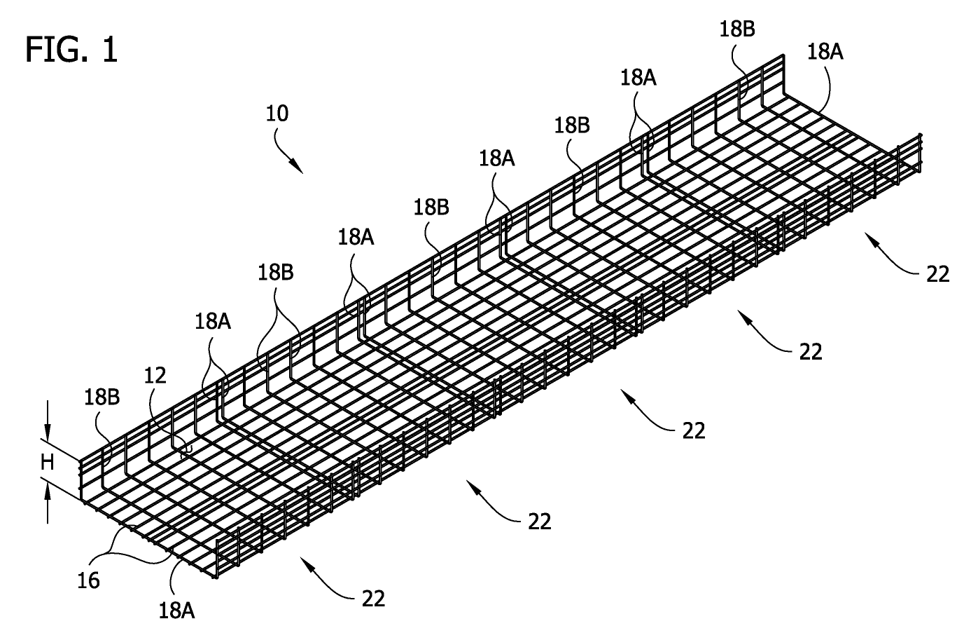

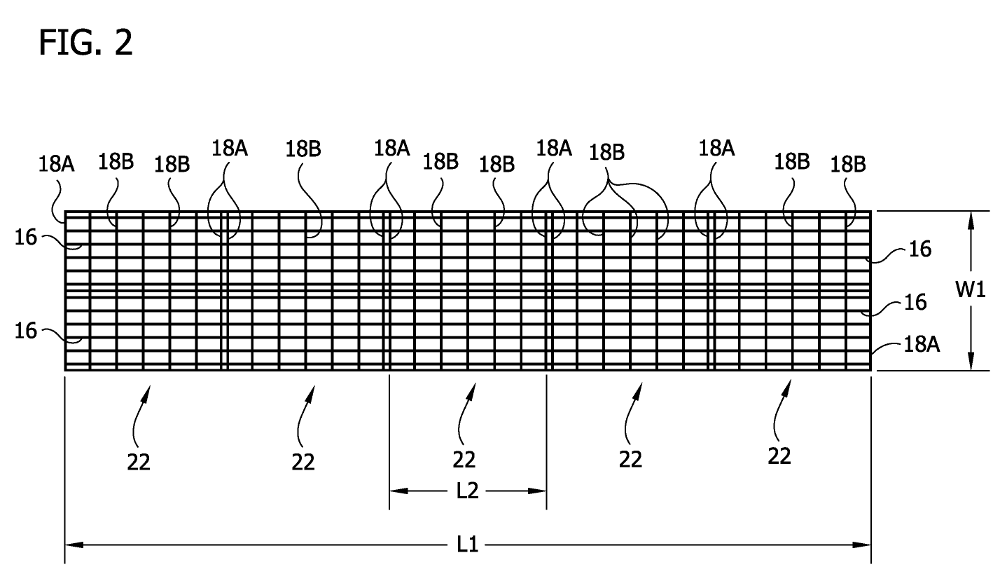

Referring now to the drawings, and in particular to FIGS. 1 and 2, one embodiment of a wire tray stock constructed according to the teachings of the present invention is generally indicated at 10. The illustrated wire tray stock configured as a wire cable basket having a generally U-shaped cross-section defining a channel 12 with open longitudinal ends. It is understood that the wire tray stock 10 may have other configurations without departing from the scope of the present invention. By way of example but not limitation, the wire tray may be generally configured as planar grating. Other configurations are possible. The wire tray stock 10 of the illustrated embodiment has a length L1 of about 302.8 cm (119.2 in), a width W1 of about 50.8 cm (20 in), and a height of about 15.24 cm (6 in). The wire tray stock 10 may have other dimensions. For example, the wire tray stock 10 can have a width of about 15.24 cm (6 in) or about 30.48 cm (12 in) and can have a height of about 5.08 cm (2 in) or about 10.16 cm (4 in). Other lengths of the wire tray stock are discussed below.

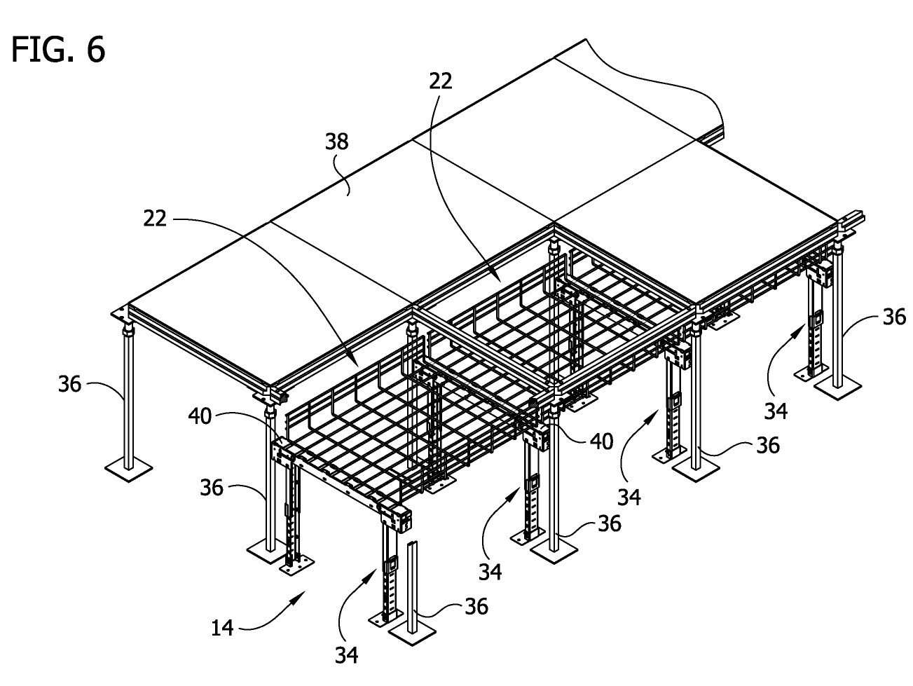

As will become apparent throughout this disclosure, the wire tray stock 10 of the illustrated embodiment is particularly suited for use with an underfloor management system comprising a series support stands having support surfaces on which wire trays are mounted. In particular, the wire tray stock 10 is suited for use with an underfloor management system generally designated 14 in FIG. 6 and described in U.S. patent application Ser. No. 11/866,647, assigned to the assignee of the present application. The underfloor management system 14 will be explained in more detail below.

Referring to FIGS. 1 and 2, the wire tray stock 10 comprises a plurality of parallel longitudinal wires 16 extending along the length L1 of the tray stock. The longitudinal wires 16 are spaced apart from one another across the width W1 of the tray stock. A plurality of generally parallel U-shaped cross wires 18A, 18B extending transverse to the length L1 of the tray stock 10 are secured to the longitudinal wires 16, e.g., to the upper portions of the longitudinal wires. (The distinction between the cross wires indicated at 18A and those indicated at 18B will be explained below.) It is understood that the cross wires 18A, 18B may be substantially straight or have other shapes without departing from the scope of the present invention. The cross wires 18A, 18B are spaced apart from one another and laid out along the length L1 of the tray stock 10 so as to define a plurality of individual wire tray modules, each generally indicated at 22, that are integrally connected to one another along the length of the wire tray stock. In the illustrated embodiment, the wire tray stock 10 includes five (5) wire tray modules, although it is understood that the wire tray stock can include more or less modules within the scope of the present invention. The tray modules 22 have substantially uniform lengths L2. For example and without limitation, the tray modules 22 may have uniform lengths L2 of between about 65 cm (25.6 in) and about 55 cm (21.7 in). In the illustrated embodiment, the tray modules 22 have lengths L2 of about 59.5 cm (23.2 in). The modules 22 may have other uniform lengths L2 without departing from the scope of the invention. The lengths L2 of the modules 22 may be dependent on the layout of the underfloor management system 14.

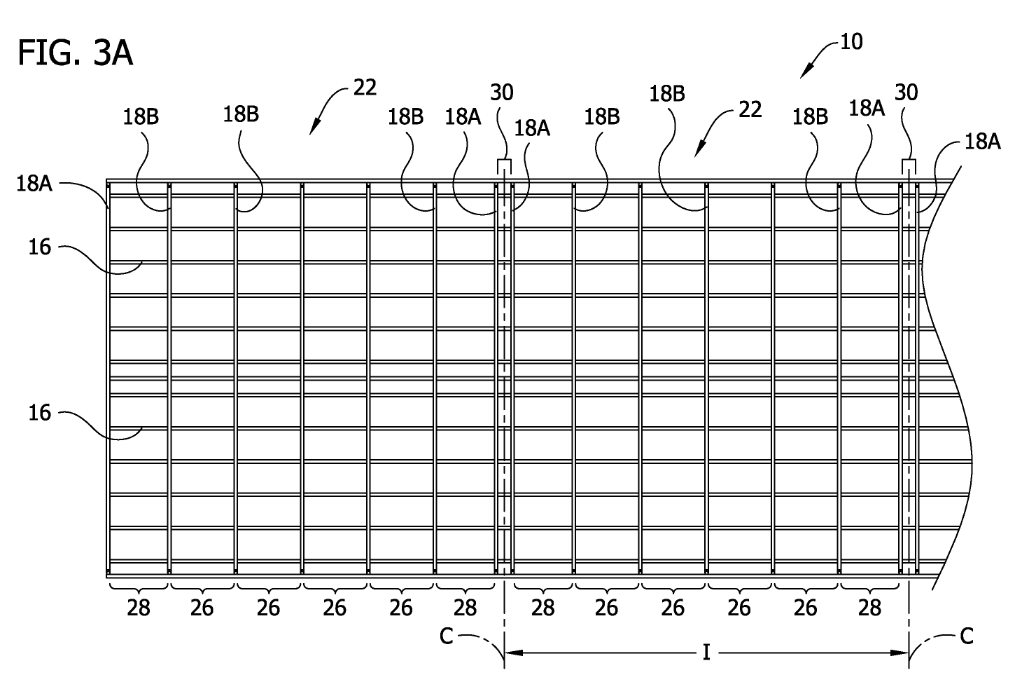

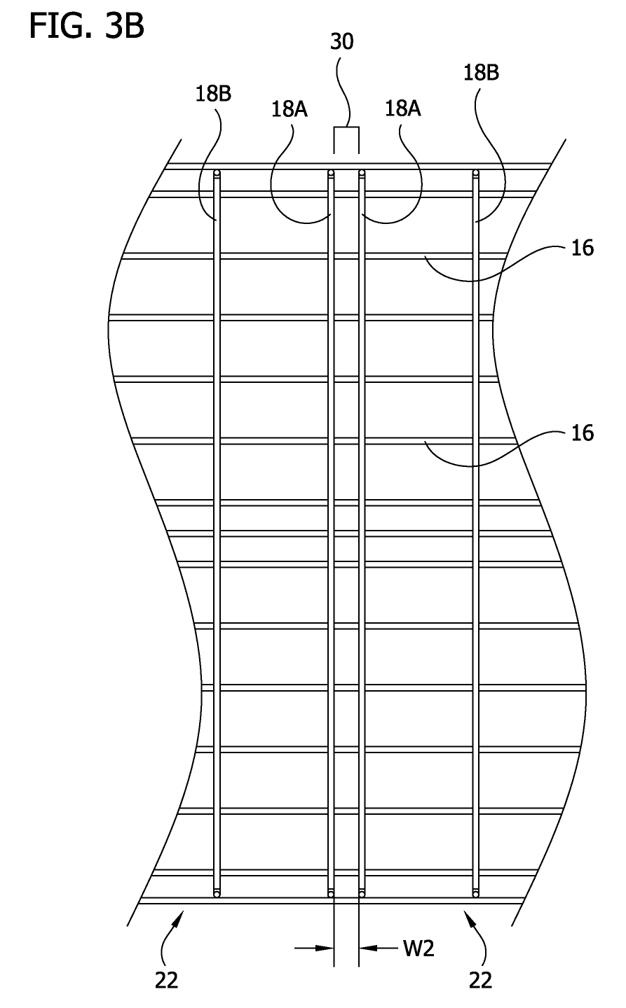

Referring to FIGS. 1-3A, each wire tray module 22 includes two cross wires designated 18A, which constitute “end cross wires” and define opposite longitudinal ends of the tray module. Each tray module 22 also includes a plurality of the cross wires 18B, which constitute “intermediate cross wires”, that are disposed between the corresponding end cross wires 18A. Referring to FIG. 3A, the intermediate cross wires 18B of each tray module 22 are spaced apart from one another by first distance intervals 26 along the length L2 of the tray module. In one example, the first distance intervals 26 are generally uniform, each measuring about 10.0 cm (3.9 in). The respective intermediate cross wires 18B that are adjacent to the end cross wires 18A are spaced from the corresponding end cross wires by second distance intervals 28. In one example, the second distance intervals 28 are generally uniform and measure about 9.2 cm (3.6 in).

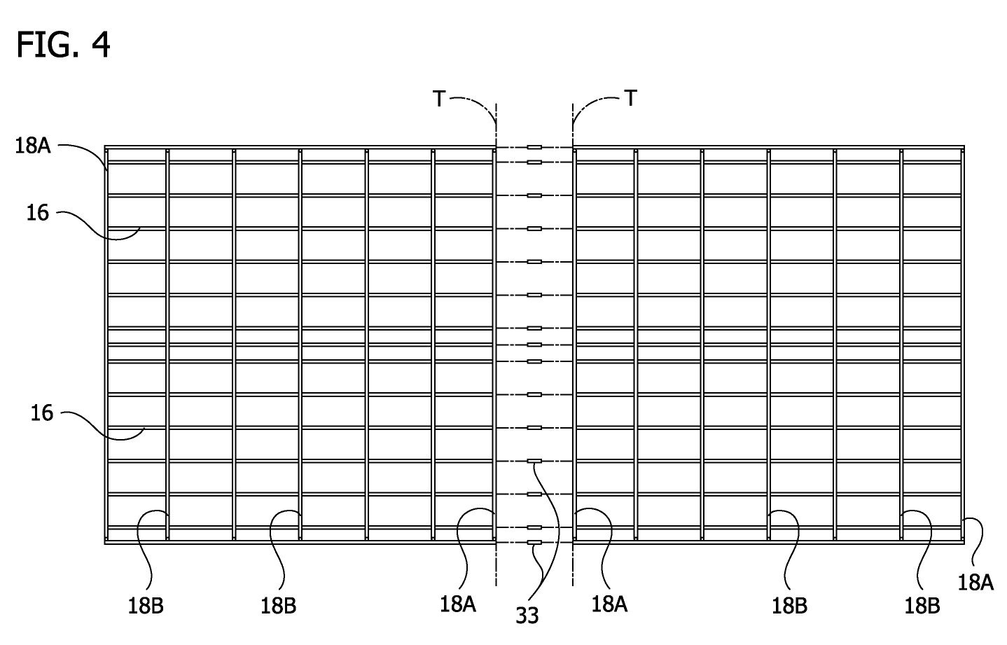

Referring to FIGS. 3A, 3B and 4, the wire tray stock comprises a plurality of cross-cut zones 30 disposed between adjacent end cross wires 18A of adjacent wire tray modules 22. In one embodiment, the cross-cut zones 30 are disposed at generally uniform intervals along the length L1 of the wire tray stock 10. For example, centerlines C (FIG. 3A) of the cross-cut zones 30 may be spaced at intervals I of about 61 cm (24 in) along the length L1 of the wire tray stock 10. Referring to FIG. 3B, each cross-cut zone 30 has width W2 defined by the spacing between the adjacent end cross wires 18A of adjacent tray modules 22. In one embodiment, the widths W2 of the cross-cut zones 30 are less than the first distance intervals 26 between the intermediate cross wires 18B and less than the second distance intervals 28 between adjacent intermediate cross wires and respective end cross wires 18A. In one example, the widths W2 of the cross-cut zones 30 are generally uniform, each measuring between about 0.5 in (1.3 cm) and 5.1 cm (2.0 in), and more preferably about 2.5 cm (1.0 in). Other widths W2 are suitable.

Referring to FIGS. 1-4, it will be observed that the wire tray modules 22 are readily visually discernible from one another along the length L1 of the wire tray stock 10 because the distances between adjacent end cross wires 18A of adjacent modules (i.e., the widths W2 of the cross-cut zones 30) are less than and desirably significantly less than the first distance intervals 26 and the second distance intervals 28. By way of example but not limitation, W2 is desirably at least 10% less than intervals 26 and 28, even more desirably at least 20% less than intervals 26 and 28, even more desirably at least 30% less than intervals 26 and 28, even more desirably at least 40% less than intervals 26 and 28, and even more desirably at least 50% less than intervals 26 and 28. Because the modules 22 are visually separated by the cross-cut zones 30, workers at a job site will not waste time measuring individual wire tray modules 22 along the length L1 of the wire tray stock 10 before cutting the stock, as with conventional wire tray stock having cross wires spaced at uniform intervals along the entire length of the stock. Instead, the individual tray modules 22 are readily discernible simply by looking at the wire tray stock 10.

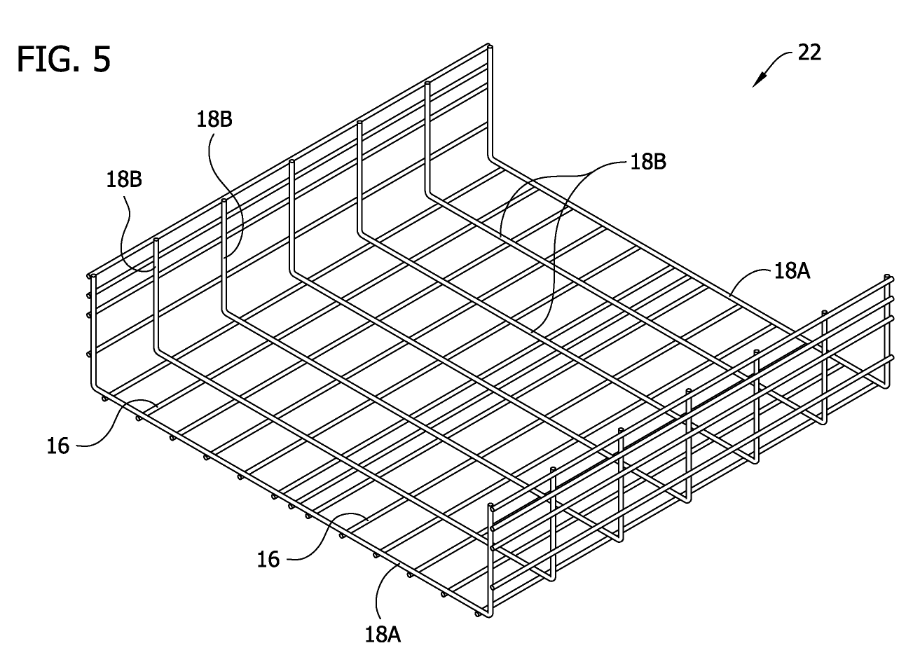

According to one method of use, a worker(s) at the jobsite cuts individual wire basket modules 22 from the tray stock 10 by transversely cutting the longitudinal wires 16 at the cross-cut zones 30 (i.e., between the adjacent end cross wires 18A of adjacent tray modules). This procedure is illustrated in FIG. 4, which shows a length of tray stock 10 comprising two modules 22. To remove a tray module 22 from the tray stock 10, the longitudinal wires are cut along two transverse lines T located within the cross-cut zone 30 generally adjacent to respective end cross wires 18A defining the cross-cut zone. Portions 33 of the longitudinal wires 16 in the cross-cut zone 30 are scrap. A resultant module 22 is illustrated in FIG. 5. Alternatively, a single cut can be made through the cross-cut zone 30, preferably substantially along the centerline C.

Referring to FIG. 6, the separated wire tray modules 22 are mounted on a plurality of modular stands, each generally indicated at 34, of the underfloor management system 14. The modular stands 34 are disposed between pedestals 36 of a raised floor 38 and include horizontal support surfaces 40 on which the tray modules 22 are mounted. The wire tray modules 22 span across adjacent and aligned stands 34 when mounted thereon. As shown in FIG. 6, the support surface 40 of each stand 34 allows end cross wires 18A of two, generally aligned tray modules 22 to engage the support surface. The modules 22 can be secured to the stands 34 by cable ties, clips or other fastening devices.

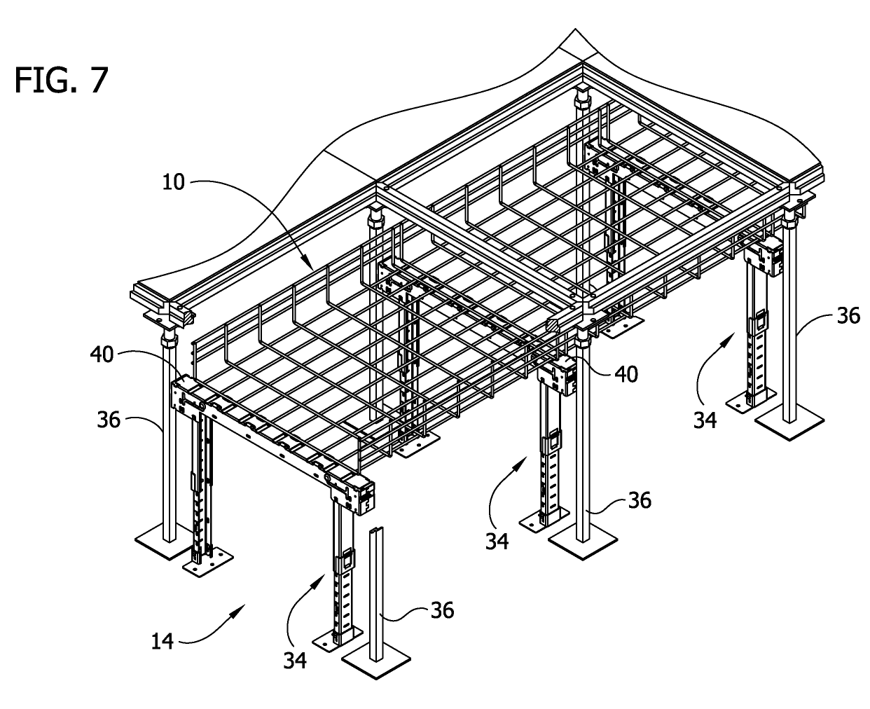

In an alternative method of use, the worker(s) keeps the stock 10 intact and/or does not cut each and every module 22 from the stock so that at least two of the modules remain integrally connected. In this method (e.g., see FIG. 7), the two or more integral modules 22 are mounted as a unit, preferably spanning across three or more aligned stands 34. For this embodiment, a desirable spacing between adjacent modules 22 (i.e., the width W2 of a cross-cut zone 30) is generally less than the width of the support surface 40 of each stand 34 on which the modules 22 are mounted. In this way, the relatively narrow cross-cut zones 30 give the worker the option of either cutting each module 22 from the stock 10 and mounting the modules individually on the stands 34 or mounting two or more modules as an integral unit on the stands, without moving one or more stands from their preferred modular arrangement in which they are positioned between respective pedestals 36 of the raised floor 38. For example and without limitation, the pedestals 36 in the illustrated embodiments of FIGS. 6 and 7 are spaced 24 inches apart from one another to form a 2′×2′ grid, and therefore, the stands 34 are also spaced 24 inches apart from one another. Because the centerlines C of the cross-cut zones 30 are spaced apart at intervals I measuring 24 inches, the centerlines of the cross-cut zones will substantially align with longitudinal centerlines of the support surfaces 40 of the stands extending transverse to the widths of the support surfaces. Further, because the widths W2 of the cross-cut zones 30 are less than the widths of the support surfaces 40 of the stands 34, respective adjacent end cross wires 18A of adjacent modules 22 will engage the support surface regardless of whether the modules are detached from the stock 10 and mounted individually on the stands or whether two or more modules remain integrally connected and are mounted on the stands as a unit.

In yet another exemplary method of use, the wire tray stock 10 is mounted above the floor using, for example, hangers and support rods secured to framing in a building. As is generally known in the art, building requirements require hangers or other types of tray supports to be secured to the tray at certain intervals along the length of the tray. For example, depending on the load requirement for a particular application, the tray may need to be supported at either 2 ft intervals, or 4 ft intervals or 6 ft intervals. Accordingly, the end cross wires 18A, which are spaced apart by 2 ft intervals, serve as visual references and indicators for installers and/or inspectors to ensure that the trays are supported at the required intervals without measuring the location of each tray support.

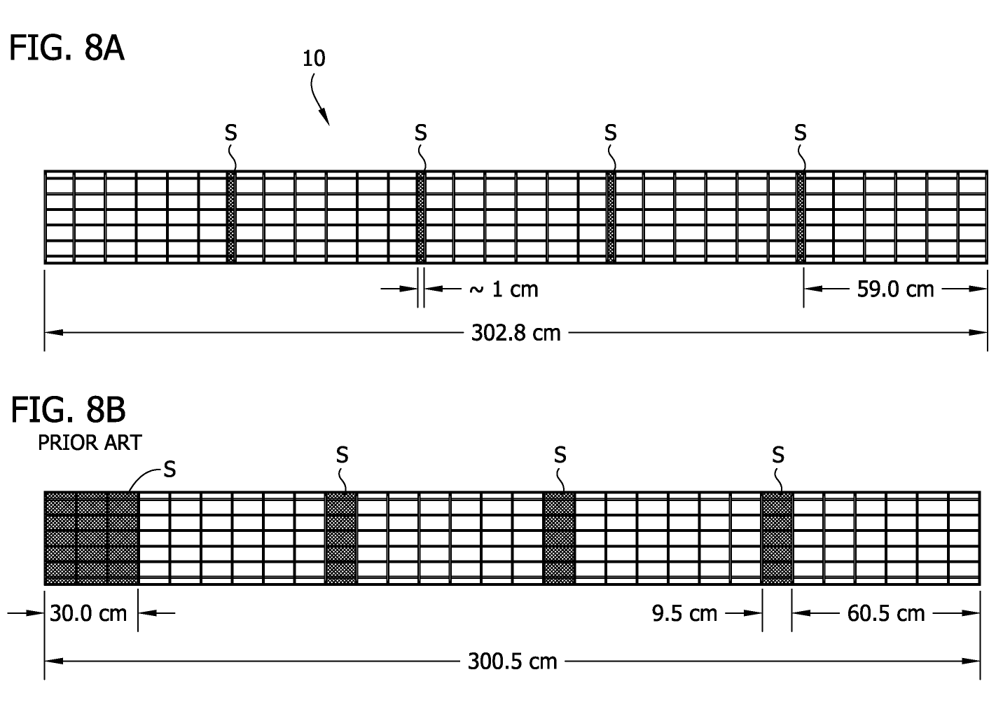

In addition to increasing efficiency at the job site, the configuration of the wire tray stock 10 also reduces scrap resulting from the removal (i.e., cutting) of the individual tray modules 22 from the tray stock and allows for a greater number of tray modules to be contained within a single piece of tray stock as compared to conventional tray stock of the same or slightly shorter length. Scrap regions of the stock 10 are shaded and indicated by reference character “S” in FIG. 8A. In one embodiment, the percentage of scrap resulting when all of the tray modules 22 are individually cut from the tray stock 10 is less than about 20%, more desirably less than about 10%, even more desirably less than about 5%, and still more desirably less than about 2%. In the illustrated embodiment, the detailed specifications of which are given above, the percentage of scrap is less about 2%. Also, the combined widths W2 of the cross-cut zones 30 are desirably less than about 10% of the overall length L1 of the wire tray stock 10, more desirably less than about 5%, and even more desirably, less than about 2%. In the illustrated embodiment, the combined widths W2 of the cross-cut zones 30 are about 2% of the overall length L1 of the wire tray stock 10.

In comparing the wire tray stock 10 of FIG. 8A to a conventional wire tray unit illustrated in FIG. 8B, it is apparent that the conventional wire tray unit does not provide the above-referenced advantages provided by the illustrated wire tray stock. All of the cross wires of the illustrated conventional wire tray unit in FIG. 8B are spaced apart from one another by uniform intervals measuring 10.0 cm (3.9 in), which are equal to the first distance intervals between the intermediate cross wires 18B of the wire tray stock 10. Moreover, the length of the conventional wire tray unit is slightly shorter (i.e., 2.8 cm (1.1 in)) than the length of the illustrated wire tray stock 10. Scrap regions of the prior art wire tray are shaded and indicated by reference character “S” in FIG. 8B. Through this comparison, it can be seen that the conventional wire tray unit produces 20% scrap when wire basket segments having lengths suitable for use with the underfloor management system 14 in FIGS. 6 and 7 (i.e., about 60.5 cm (23.8 in)) are cut from the unit. Moreover, it is also evident through this comparison that only four trays having about the same lengths as the modules 22 of the illustrated embodiment can be cut from the conventional wire tray unit, while five modules can be cut from the illustrated wire stock of the present invention. Moreover still, it is also apparent that the conventional wire tray unit produces a large amount of scrap at one of its longitudinal ends. As shown in the illustrated embodiment of the present invention, it is desirable that only the portions of the tray stock 10 disposed in the cross-cut zones 30 become scrap and that no scrap is produced at the ends of the wire tray stock. In other words, it is preferred that the end cross wires 18A of the respective modules 22 disposed at the ends of the wire tray stock 10 constitute the respective ends of the wire tray stock.

In one embodiment, the wire tray stock 10 is manufactured by feeding the longitudinal wires 16 having uniform, selected lengths (e.g., about 3033 cm (119.4 in)) along an assembly line and securing (i.e., welding) straight cross wires 18A, 18B of uniform, selected lengths to the longitudinal wires at selected intervals, as taught above, to form a grate-like construction. After forming the grate-like construction of cross wires 18A, 18B and longitudinal wires 16, the cross wires are bent using a press brake, for example, into U-shapes. Other ways of forming the wire tray stock are within the scope of the present invention.

In one example, the wire tray stock 10 is offered for sale. The customer purchases a desirable length of the tray stock 10 comprising two or more modules 22 integrally connected to one another. At the job site, individual wire tray modules 22 are selectively cut from the wire tray stock and mounted underneath the raised floor system so that the individual wire tray modules form a raceway for the wires underneath the raised floor.

The tray modules may be offered for sale in wire tray stock of varying lengths, based on the number of modules needed. In one embodiment, a manufacturer or retailer or distributor may offer several types of wire tray stock. For example, the manufacturer or retailer or distributor may sell a maximum-length wire tray stock having a length containing a maximum number of wire tray modules 22 (e.g., five as illustrated); one or more intermediate-length wire tray stocks, each having a shorter length than the maximum-length wire tray stock and a correspondingly fewer number of wire tray modules 22 (e.g., three); and a minimum-length wire tray stock having a length containing two or more wire tray modules. Individual wire tray modules 22 may also be offered for sale.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. Wire tray stock comprising:
adjacent first and second wire tray modules extending along a length of the wire tray stock, said modules being integrally connected to one another and having generally uniform lengths,
a cross-cut zone extending transverse to the wire tray stock between said first and second tray modules,
each of said first and second modules comprising
opposite end cross wires extending generally transverse to the length of the wire tray stock and defining opposite longitudinal ends of said wire tray module, and
a plurality of intermediate cross wires disposed between said end cross wires and extending generally transverse to the length of the wire tray stock, adjacent cross wires of said plurality of intermediate cross wires being spaced apart by first distance intervals along the length of said wire tray stock,
the cross-cut zone having a width defined by the distance between adjacent end cross wires of the first and second tray modules, said width being less than said first distance intervals between the intermediate cross wires of said wire tray modules, the first and second wire tray modules being detachable from each other by cutting through said cross-cut zone.

2. Wire tray stock as set forth in claim 1 wherein the first distance intervals are generally uniform.

3. Wire tray stock as set forth in claim 2 wherein said end cross wires and said intermediate cross wires have the same cross-sectional shape and size.

4. Wire tray stock as set forth in claim 2 wherein the end cross wires are spaced from respective adjacent intermediate cross wires of said plurality of intermediate cross wires by second distance intervals less than said first distance intervals.

5. Wire tray stock as set forth in claim 4 wherein the second distance intervals are generally uniform.

6. Wire tray stock as set forth in claim 5 wherein said cross wires are generally U-shaped so that the wire tray modules are configured generally as baskets.

7. Wire tray stock as set forth in claim 2 further comprising:
a third wire tray module extending along the length of the wire tray stock, said third tray module being integrally connected to said second tray module and having substantially the same structure as the first and second tray modules;
and a second cross-cut zone extending transverse to the wire tray stock between said second and third tray modules,
the cross-cut zone having a width defined by the distance between adjacent end cross wires of the second and third tray modules, said width of the second cross-cut zone being generally equal to the width of the first cross-cut zone between the first and second tray modules.

8. Wire tray stock as set forth in claim 1 in combination with a support stand having a support surface on which the tray stock can be mounted, the support stand comprising a support surface having a width greater than the width of the cross-cut zone so that the adjacent end cross wires of the connected first and second tray modules can engage the support surface without cutting the tray modules from the tray stock.

9. A method of making wire tray stock comprising a plurality of integral wire tray modules integrally connected to one another and having generally uniform lengths, the method comprising:
providing a plurality of generally parallel, spaced apart longitudinal wires arranged to extend along a length of the wire tray stock,
securing a plurality of first cross wires to said longitudinal wires so that the first cross wires are generally transverse to the longitudinal wires and are spaced from one another a first distance along the length of the wire tray stock,
securing at least one pair of adjacent second cross wires to said longitudinal wires so that the second cross wires of said pair are generally transverse to the longitudinal wires and spaced from one another a second distance along the length of the wire tray stock that is less than the first distance between adjacent first cross wires, said adjacent second cross wires defining a cross-cut zone between adjacent wire tray modules.

10. A method of making wire tray stock as set forth in claim 9 wherein the second distance between said adjacent second cross wires of said at least one pair is between about 1.0 in and about 0.4 in.

11. A method of making wire tray stock as set forth in claim 10 wherein the second distance is about 0.6 in.

12. A method of making wire tray stock as set forth in claim 9 wherein said securing at least one pair of adjacent second cross wires comprises securing at least two pairs of said adjacent cross wires to said longitudinal wires, said at least two pairs being spaced at generally uniform intervals along the length of the wire tray stock.

13. A method of selling wire tray stock comprising the step of:
offering for sale said wire tray stock comprising a plurality of wire tray modules integrally connected and spaced apart along a length of the wire tray stock,
the wire tray modules being visually discernible from each other along the length of the wire tray stock so that the modules can be identified and selectively cut from the wire tray stock in the field.

14. A method of selling wire tray stock as set forth in claim 13 wherein each of said plurality wire tray modules comprises
opposite end cross wires extending generally transverse to the length of the wire tray stock and defining opposite longitudinal ends of said wire tray module,
a plurality of intermediate cross wires disposed between said end cross wires and extending generally transverse to the length of the wire tray stock, adjacent cross wires of said plurality of intermediate cross wires being spaced apart by first distance intervals along the length of said wire tray module,
wherein adjacent wire tray modules of said plurality of wire tray modules are spaced apart from each other along the length of the wire tray stock, said adjacent wire tray modules together defining a cross-cut zone therebetween having a width extending between respective end cross wires of said adjacent wire tray modules,
wherein the width of the cross-cut zone is less than one of said first distance intervals between the intermediate cross wires of each of said wire tray modules so that said wire tray modules are individually discernible from each other and can be individually detached from the wire tray stock by cutting through the cross-cut zone.

15. Wire tray stock comprising:
a plurality of wire tray modules extending along a length of the wire tray stock, said modules being integrally connected to one another and having generally uniform lengths,
a plurality of cross-cut zones extending transverse to the wire tray stock between said modules,
each wire tray module of said plurality of modules comprising
opposite end cross wires extending generally transverse to the length of the wire tray stock and defining opposite longitudinal ends of said wire tray module, and
a plurality of intermediate cross wires disposed between said end cross wires and extending generally transverse to the length of the wire tray stock, adjacent cross wires of said plurality of intermediate cross wires being spaced apart by first distance intervals along the length of said wire tray stock,
each cross-cut zone of said plurality of cross-cut zones having a width defined by the distance between adjacent end cross wires of respective adjacent tray modules, wherein the combined widths of the cross-cut zones are less than about 20% of the length of the wire tray stock.

16. Wire tray stock as set forth in claim 15 wherein the combined widths of said cross-cut zones are less than about 10% of the length of the wire tray stock.

17. Wire tray stock as set forth in claim 16 wherein the combined widths of said cross-cut zones are less than about 5% of the length of the wire tray stock.

18. Wire tray stock as set forth in claim 17 wherein the combined widths of said cross-cut zones are less than about 2% of the length of the wire tray stock.

19. Wire tray stock as set forth in claim 18 wherein the width of said cross-cut zone is less than one of said first distance intervals.
